(19) United States
(12) Patent Application Publication
(10) Pub. No.: US 2021/0292628 A1
(43) Pub. Date: Sep. 23, 2021

(54) Dielectric Thermal Management Fluids and Methods for Using Them

(71) Applicant: BP P.L.C., London (GB)

(72) Inventors: Giles Michael Derek PRENTICE, Pangbourne, Reading (GB); Kevin Richard WEST, Pangbourne, Reading (GB)

(21) Appl. No.: 17/257,557

(22) PCT Filed: Jul. 3, 2019
(86) PCT No.: PCT/EP2019/067921

§ 371 Date: Dec. 31, 2020

(30) Foreign Application Priority Data
Jul. 4, 2018 (GB) 1811002.3

(51) Int. Cl. C09K 5/04; H01M 10/6567; H01M 10/613; H01M 10/0525; F28D 15/00

(52) U.S. Cl. CPC C09K 5/048; H01M 10/6567; F28D 15/00; H01M 10/0525; H01M 10/613

(57) ABSTRACT

This disclosure relates generally to thermal management fluids. This disclosure relates more particularly to dielectric thermal management fluid that includes one or more dielectric fluids and one or more halocarbons, and methods of using such thermal management fluids.

### BACKGROUND OF THE DISCLOSURE

### Field of the Disclosure

This disclosure relates generally to thermal management fluids. This disclosure relates more particularly to dielectric thermal management fluids useful in cooling electronic devices such as lithium-ion batteries, and methods of using such thermal management fluids.

### Technical Background

It is estimated that an increased number of electric vehicles (i.e., vehicles using electric power for all or a portion of their motive power such as battery electric vehicles (BEVs), hybrid electric vehicles (HEVs), plug-in hybrid electric vehicles (PHEVs), and the like) will be sold globally. Ultimately, the vast majority of vehicles will likely be electric. As electric vehicle technology continues to evolve, there is a need to provide improved power sources (e.g., battery systems or modules). For example, it is desirable to increase the distance that such vehicles may travel without the need to recharge the batteries, to improve the performance of such batteries, and to reduce the costs and time associated with battery charging.

Currently, battery-powered electric vehicles almost exclusively use lithium-ion battery technology. Lithium-ion batteries offer many advantages over the comparable nickel-metal-hydride batteries, but as compared to nickel-metal-hydride batteries, lithium-ion batteries are more susceptible to variations in battery temperature and thus have more stringent thermal management requirements. For example, optimal lithium-ion battery operating temperatures are in the range of 10 and 35° C. Operation is increasingly inefficient as temperatures rise from 35 to 70° C., and, more critically, operation at these temperatures damages the battery over time. Temperatures over 70° C. present significant risk of thermal runaway. As a result, lithium-ion batteries require systems to regulate their temperatures during vehicle operation. In addition, during charging, up to 10% of the inputted power ends up as heat. As the fast charging of lithium-ion batteries becomes more common, the need remains for efficient systems for thermal management of the batteries.

Lithium-ion batteries may be cooled directly or indirectly, using thermal management fluids to carry heat away from the battery component (i.e., as a cooling fluid or coolant). Direct cooling advantageously allows the thermal management fluid to come into direct contact with the hot components to carry heat away therefrom. In indirect cooling, a hot component is electrically shielded by an electrically-insulating barrier and the thermal management fluid carries away heat passing through this barrier. The most common thermal management fluids are based on mixtures of water with glycol. But because water-based fluids typically conduct electricity, they cannot be used in the direct cooling of electrical components of lithium-ion batteries. While indirect cooling allows for water-based coolants to be used, the requirement of electrical shielding can create a bottleneck for the cooling process. There exist dielectric thermal management fluids that can be used for direct cooling of electrical components due to their non-electrically-conductive nature; examples include those conventionally used in the cooling of electrical transformers. However, the thermal properties of such dielectric thermal management fluids are typically poor in comparison to water-glycol.

Thus, there remains a need for improved dielectric thermal management fluids, especially those suitable for use in the cooling of lithium-ion batteries.

### SUMMARY OF THE DISCLOSURE

One aspect of the disclosure provides dielectric thermal management fluids including: one or more dielectric fluids present in a total amount in the range of 65 wt % to 99.9 wt %; and one or more halocarbons each having a boiling point in the range of 30° C. to 150° C., present in a total amount in the range of 0.1 wt % to 35 wt %, wherein the one or more halocarbons are homogeneously dispersed in the thermal management fluid; wherein the dielectric thermal management fluid has a dielectric constant of at least 1.5 at 25° C.; and wherein the thermal management fluid has a flash point that is above the boiling point of each of the one or more halocarbons.

Another aspect of the disclosure provides a method including passing a thermal management fluid of the disclosure over a surface having a temperature of at least 30° C., the surface being in substantial thermal communication with a heat source; and absorbing thermal energy in the thermal management fluid from the heat source through the surface.

In another aspect the disclosure provides a battery pack including a housing; one or more electrochemical cells disposed in the housing; a fluid path extending through the housing and in substantial thermal communication with the one or more electrochemical cells; and a thermal management fluid of the disclosure disposed in the fluid path.

In another aspect the disclosure provides a thermal management circuit including: a fluid path extending around and/or through a heat source; and a thermal management fluid of the disclosure, disposed in and configured to circulate in the fluid path and to absorb thermal energy produced by the heat source, wherein the fluid is disposed in the fluid path, the heat exchanger, the pump and the connecting duct.

### BRIEF DESCRIPTION OF THE DRAWINGS

The accompanying drawings are included to provide a further understanding of the compositions and methods of the disclosure, and are incorporated in and constitute a part of this specification. The drawings are not necessarily to scale, and sizes of various elements may be distorted for clarity. The drawings illustrate one or more embodiment(s) of the disclosure, and together with the description serve to explain the principles and operation of the disclosure.

FIG. 1 is a schematic cross-sectional view of a thermal management circuit according to an embodiment of the disclosure.

FIG. 2 is a schematic cross-sectional view of a thermal management circuit according to another embodiment of the disclosure.

FIG. 3 is a schematic depiction of a cooling operation of a thermal management fluid of the disclosure.

### DETAILED DESCRIPTION

The particulars shown herein are by way of example and for purposes of illustrative discussion of certain embodiments of the present invention only and are presented in the cause of providing what is believed to be the most useful and readily understood description of the principles and conceptual aspects of various embodiments of the invention. In this regard, no attempt is made to show structural details of the invention in more detail than is necessary for the fundamental understanding of the invention, the description taken with the drawings and/or examples making apparent to those skilled in the art how the several forms of the invention may be embodied in practice. Thus, before the disclosed processes and devices are described, it is to be understood that the aspects described herein are not limited to specific embodiments, apparatus, or configurations, and as such can, of course, vary. It is also to be understood that the terminology used herein is for the purpose of describing particular aspects only and, unless specifically defined herein, is not intended to be limiting.

The terms “a,” “an,” “the” and similar referents used in the context of describing the invention (especially in the context of the following embodiments and claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

All methods described herein can be performed in any suitable order of steps unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “above,” and “below” and words of similar import, when used in this application, shall refer to this application as a whole and not to any particular portions of the application.

As will be understood by one of ordinary skill in the art, each embodiment disclosed herein can comprise, consist essentially of or consist of its particular stated element, step, ingredient or component. As used herein, the transition term “comprise” or “comprises” means includes, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the embodiment to the specified elements, steps, ingredients or components and to those that do not materially affect the embodiment.

All percentages, ratios and proportions herein are by weight, unless otherwise specified.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Some embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

The present inventors have noted that, in certain cases, desirable dielectric thermal management fluids would have a high capacity to carry heat away in a temperature range relevant to operation of a particular electrical device or system (e.g., a lithium-ion battery), yet have a sufficiently high dielectric constant to be suitable for use in direct cooling of the device or system. Moreover, because there is always a risk that oxygen might enter the overall system, desirable thermal management fluids would advantageously have a high or ideally no flash point, to reduce the risk of ignition.

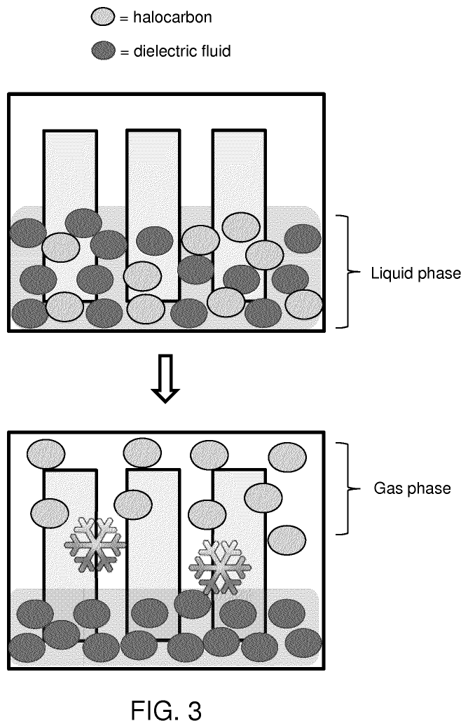

The present inventors have identified dielectric thermal management fluid compositions that utilize the phase change and chemical inertness properties of certain halocarbon materials with the superior dielectric properties and thermal conductivity of organic dielectric fluids. Specifically, the present inventors recognized that certain halocarbons can undergo a phase change (i.e., liquid to gas) at temperatures relevant to the operation of electrical devices and systems such as lithium-ion batteries. This phase change can be used in a cooling system, with the latent heat of vaporization being used to provide cooling of an electrical component, as schematically shown in FIG. 3. Moreover, many halocarbons have high flash points, or even no flash point at all. Thus, even though the vaporization of halocarbon can create a high concentration of halocarbon vapor in the system, there is little risk of ignition of the vapor. Halocarbons can also generally have advantageously low viscosities and high densities. Many halocarbons, however, have poor thermal conductivity and specific heat capacity. By comparison, dielectric fluids (e.g., organic or silicone) typically have good thermal conductivity and specific heat capacity. The present inventors have determined that vaporization-based cooling as described herein can be advantageously provided by one or more suitable halocarbons dispersed in one or more suitable dielectric fluids. It is the synergistic combination of halocarbon with dielectric fluid that results in the improved thermal management fluid of the disclosure, with the halocarbon component providing vaporization-based cooling without risk of ignition, and the dielectric fluid component providing desirable heat flow and handling properties, and both fluids providing the dielectric properties necessary for direct cooling of electrical devices and systems.

The thermal management fluids and methods of the disclosure can have a number of advantages over conventional fluids. Notably, vaporization typically requires much more energy than mere temperature increase of a fluid. Accordingly, because the mechanism of cooling can include the vaporization of the halocarbon component of the dielectric thermal management fluid, the thermal management fluids can have a high overall capacity for cooling. The vaporization of the halocarbon component can also provide provide a high rate of cooling, which can be especially desirable in the context of lithium-ion batteries to help protect against thermal runaway. And because a halocarbon component can be selected with a desired boiling point, the person of ordinary skill in the art can provide fluids that have high heat capacities at one or more desired temperatures, in order to maintain the temperature of an electrical device or system within a desired operating range. The combination of materials in the dielectric fluids of the disclosure can also, in various embodiments, provide one or more of desirably low viscosity, high heat conductivity, low risk of ignition, high dielectric constant, high density and faster temperature response.

In general, the aspects and embodiments of the disclosure provide improvements in thermal management fluids, for example, suitable for use as dielectric coolants for electrical devices and systems such as lithium-ion batteries. Specifically, as illustrated in FIG. 3, the thermal management compositions of the disclosure combine the phase change properties of one or more halocarbons with the superior thermal conductivity and specific heat capacity of the one or more dielectric fluids. In various compositions and methods of the disclosure, the halocarbon component absorbs heat in the neighborhood of its boiling point(s) by vaporizing into the gas phase. This can provide a targeted absorption of heat at one or more desired temperatures corresponding to the boiling point(s) of the halocarbon components. The particular amounts and identities of the one or more halocarbons can be selected based on the disclosure here in to provide the desired heat absorption at the desired temperatures. Notably, it is possible to provide a thermal management fluid comprising a variety of halocarbons, each with a different boiling point and each in a different amount, such that the liquid halocarbons vaporize over a range of temperatures. This results in the thermal management fluid being able to provide a desired cooling profile as a function of temperature. The vaporized halocarbon(s) can condense into a liquid phase (e.g., using external cooling such as on a heat exchanger, or through a drop in temperature of the component being cooled), ready to be revaporized during subsequent heating cycles of the thermal management fluid.

Thus, one aspect of the disclosure provides dielectric thermal management fluids including: one or more dielectric fluids present in a total amount in the range of 65 wt % to 99.9 wt %; and one or more halocarbons each having a boiling point in the range of 30° C. to 150° C., present in a total amount in the range of 0.1 wt % to 35 wt %, wherein the one or more halocarbons are homogeneously dispersed in the thermal management fluid; wherein the dielectric thermal management fluid has a dielectric constant of at least 1.5 at 25° C.; and wherein the thermal management fluid has a flash point that is above the boiling point of each of the one or more halocarbons.

As described above, the thermal management fluid of the disclosure comprise one or more dielectric fluids. As used herein, a dielectric fluid is a liquid at 25° C. and has a dielectric constant of at least 1.5 at 25° C. Dielectric fluids especially desirable for use herein desirably have relatively high thermal conductivity (e.g., at least 0.05 W/m·K, or at least 0.1 W/m·K, or even at least 0.12 W/m·K at 25° C.) and/or relatively high specific heat capacity (e.g., at least 1 J/g·K, or at least 1.2 J/g·K, or even at least 1.5 J/g·K at 25° C.). Various dielectric fluids known in the art can suitably be used in the compositions, systems and methods described herein. In certain desirable embodiments, the one or more dielectric fluids are non-reactive or otherwise inert with respect to components of a battery such as of a lithium-ion battery.

A wide variety of dielectric fluids can be used in the compositions, systems and methods described herein. For example, in certain embodiments as otherwise described herein, the one or more dielectric fluids may be selected from aliphatic dielectric fluids (e.g., C₁₄-C₅₀ alkyls, C₁₄-C₅₀ alkenyls, C₁₄-C₅₀ alkynyls, polyolefins such as poly-α-olefin), aliphatic dielectric fluid oxygenates (e.g., ketones, ethers, esters, or amides), aromatic dielectric fluids (e.g., dialkylbenzene such as diethylbenzene, cyclohexylbenzene, 1-alkylnaphthalene, 2-alkylnaphthalene, dibenzyltoluene, and alkylated biphenyl), aromatic dielectric fluid oxygenates (e.g., ketones, ethers, esters, or amides), silicones (e.g., silicone oil and silicate ester), and any combination thereof.

In certain embodiments as otherwise described herein, the dielectric fluid may be diesel formulated to a high flash point and optionally low sulfur content (e.g., less than 3000 ppm, less than 2000 ppm, or less than 1000 ppm).

In certain embodiments as otherwise described herein, each of the one or more dielectric fluids is an oil, e.g., a mineral oil, a synthetic oil, or a silicone oil. For example, in certain embodiments, the dielectric fluid is a low-viscosity Group III or IV base oil as defined by the American Petroleum Institute (API Publication 1509). Group III base oils (such as hydrocracked and hydroprocessed base oils as well as synthetic oils such as hydrocarbon oils, polyalphaolefins, alkyl aromatics, and synthetic esters) and Group IV base oils (such as polyalphaolefins (PAO)) are wells known base oils. Oils suitable for use as transformer oils can, in many embodiments, be suitable for use as dielectric fluids in the compositions, systems and methods of the disclosure.

Commercially available dielectric fluids include Perfecto™ TR UN (available from Castrol Industrial, United Kingdom) and MIDEL 7131 (available from M&I Materials Ltd., United Kingdom). Examples of commercially available base oils include YUBASE 3 and YUBASE 4 (available from SK Lubricants Co. Ltd., South Korea), DURASYN® 162 and DURASYN® 164 (available from INEOS Oligomers, Houston, Tex.), and PRIOLUBE™ oils (available from CRODA, United Kingdom).

Based on the disclosure herein, the one or more dielectric fluids can be selected to provide the thermal management fluids of the disclosure with a desirable overall heat capacity and thermal conductivity. Moreover, the one or more dielectric fluids can be selected to have low reactivity with respect to the other components of the systems in which they are used, and to provide the thermal management fluid with a desired viscosity. Other considerations when selecting the one or more dielectric fluids may include their dielectric constant, toxicity, environmental impact and cost.

In certain embodiments as otherwise described herein, the one or more dielectric fluids is present in the thermal management fluid in a total amount in the range of 65 wt % to 99.9 wt %, based on the total weight of the thermal management fluid. For example, in certain embodiments of the thermal management fluid as otherwise described herein, the one or more dielectric fluids is present in a total amount of 70 wt % to 99.9 wt %, or 75 wt % to 99.9 wt %, or 80 wt % to 99.9 wt %, or 85 wt % to 99.9 wt %, or 90 wt % to 99.9 wt %, or 95 wt % to 99.9 wt %, or 65 wt % to 99 wt %, or 70 wt % to 99 wt %, or 75 wt % to 99 wt %, or 80 wt % to 99 wt %, or 85 wt % to 99 wt %, or 90 wt % to 99 wt %, or 95 wt % to 99 wt %, based on the total weight of the thermal management fluid. In certain embodiments of the thermal management fluid as otherwise described herein, the one or more dielectric fluids is present in a total amount of 65 wt % to 98 wt %, e.g., 70 wt % to 99 wt %, or 75 wt % to 98 wt %, or 80 wt % to 98 wt %, or 85 wt % to 98 wt %, or 90 wt % to 98 wt %, or 95 wt % to 98 wt %, or 65 wt % to 95 wt %, or 70 wt % to 95 wt %, or 75 wt % to 95 wt %, or 80 wt % to 95 wt %, or 85 wt % to 95 wt %, or 90 wt % to 95 wt %, based on the total weight of the thermal management fluid. In certain embodiments of the thermal management fluid as otherwise described herein, the one or more dielectric fluids is present in a total amount of 65 wt % to 90 wt %, e.g., 70 wt % to 90 wt %, or 75 wt % to 90 wt %, or 80 wt % to 90 wt %, or 85 wt % to 90 wt %, or 65 wt % to 85 wt %, or 70 wt % to 85 wt %, or 75 wt % to 85 wt %, or 80 wt % to 85 wt %, or 65 wt % to 80 wt %, or 70 wt % to 80 wt %, or 75 wt % to 80 wt %, based on the total weight of the thermal management fluid. The total amount of the one or more dielectric fluids can be selected in view of the disclosure herein based, for example, on the total amount of halocarbon(s) necessary to provide the desired cooling behavior, and on the amount of other additives necessary to provide desirable properties to the thermal management fluid.

As described above, the thermal management fluids of the disclosure include one or more halocarbons. As used herein, a “halocarbon” is an organic compound that includes one or more of fluorine, chlorine, bromine and iodine. The halocarbons of the disclosure may be partially halogenated compounds (i.e., in which there are one or more C-halogen bonds but also one or more C—H bonds in the structure of the compound) or fully halogenated compounds (i.e., in which there are C-halogen bonds and no C—H bonds in the compound, such as in perfluorinated compounds).

Each of the one or more halocarbons has a boiling point (i.e. at 1 atm) in the range of 30 C to 150° C. The inventors have noted that relatively volatile halocarbons like those described here can provide a cooling effect when they vaporize from liquid to gas (i.e., as measured by their heats of vaporization) This phase transition will occur in a very narrow temperature range, and thus can serve to provide the thermal management fluid with the ability to absorb a relatively large amount of heat at a given temperature (i.e., near the boiling point of the halocarbon, in some embodiments modified by the pressure within the space in which the thermal management fluid is contained). Thus, the use of one or more halocarbons as provided herein can help to prevent thermal runaway of an electrical component by absorbing a relatively high amount of heat at one or more temperatures. Similarly, the use of one or more halocarbons as provided herein can help to quickly absorb heat evolved in a fast charging of an electrical component such as a rechargeable battery (e.g., a lithium-ion battery).

Notably, the pressure of the space in which the one or more halocarbons is contained can be regulated to provide desirable boiling point(s) for the one or more halocarbons. As the person of ordinary skill in the art will appreciate, the boiling point of a material depends on the pressure, so by regulating the pressure, the boiling point can be modified. The pressure can be regulated, for example, to be greater than atmospheric pressure to reduce the boiling point of a halocarbon. The expansion chambers described herein can be used to regulate pressure in the halocarbon-containing space.

The identity (and thus the boiling point) of each of the one or more halocarbons can be selected based on desired operating temperatures of the particular system or process under consideration. Thus, in certain embodiments as otherwise described herein, each of the one or more halocarbons has a boiling point in the range of 30° C. to 100° C., or 30° C. to 90° C., or 30° C. to 85° C., or 30° C. to 80° C., or 30° C. to 75° C., or 30° C. to 70° C. In certain embodiments as otherwise described herein, each of the one or more halocarbons has a boiling point in the range of 40° C. to 150° C., e.g., 50° C. to 150° C., or 60° C. to 150° C., or 70° C. to 150° C., or 80° C. to 150° C., or 90° C. to 150° C., or 100° C. to 150° C., or 110° C. to 150° C., or 30° C. to 100° C., or 40° C. to 100° C., or 50° C. to 100° C., or 60° C. to 100° C., or 70° C. to 100° C., or 80° C. to 100° C., or 30° C. to 90° C., or 40° C. to 90° C., or 50° C. to 90° C., or 60° C. to 90° C., or 30° C. to 85° C., or 40° C. to 85° C., or 45° C. to 85° C., or 50° C. to 85° C., or 60° C. to 85° C., or 30° C. to 80° C., or 40° C. to 80° C., or 45° C. to 80° C., or 50° C. to 80° C., or 60° C. to 80° C., or 30° C. to 75° C., or 40° C. to 75° C., or 45° C. to 75° C., or 50° C. to 75° C., or 60° C. to 75° C., or 30° C. to 70° C., or 40° C. to 70° C., or 45° C. to 70° C., or 50° C. to 70° C., or 60° C. to 70° C., or 65° C. to 75° C.

In certain embodiments as otherwise described herein, a thermal management fluid of the disclosure includes only a single halocarbon having a boiling point in the range of 30-150° C. This can provide the thermal management fluid with a single narrow temperature range over which heat can be absorbed through vaporization. However, the present inventors have noted that it can in some embodiments be preferable to provide the thermal management with two or more different halocarbons. The halocarbons can, in certain embodiments, have substantially different boiling points (e.g., at least 10° C. difference in boiling points, or at least 20° C. difference in boiling points, or even at least 50° C. difference in boiling points). This can allow for two or more separate temperatures at which vaporization can be used to absorb heat. For example, in certain embodiments, the thermal management fluid as otherwise described herein includes a first halocarbon having a boiling point in the range of 30° C. to 80° C. and a second halocarbon having a boiling point in the range of 80° C. to 150° C. In certain embodiments, the thermal management fluid as otherwise described herein includes a first halocarbon having a boiling point in the range of 30° C. to 50° C. and a second halocarbon having a boiling point in the range of 80° C. to 110° C.

However, in other embodiments, two halocarbons in a thermal management fluid can have relatively similar boiling points (e.g., no more than 5° C. difference in boiling points, or no more than 2° C. difference in boiling points, or no more than 1° C. difference in boiling points). In such cases, the two halocarbons may not provide a difference in vaporization temperature, but instead allow the tuning of other physical properties of the overall thermal management fluid.

When two or more halocarbons are used in a thermal management fluid, the relative amounts of the two can be varied based on the disclosure herein, depending on the effect desired. In certain embodiments, the mass ratio of a first halocarbon to a second halocarbon is in the range of 1:9 to 9:1.

A variety of halocarbons can be used in the thermal management fluids of the disclosure. In certain embodiments as otherwise described herein, each of the one or more halocarbons includes as its halogen(s) one or more or chlorine, fluorine and bromine. In certain embodiments as otherwise described herein, each of the one or more halocarbons may be selected from a fluorocarbon, chlorocarbon, and chlorofluorocarbon. For example, suitable fluorocarbons include, but are not limited to, fluoroalkanes and oxygenates thereof (such as perfluoropentane, perfluorohexane, perfluoroheptane, perfluorocyclohexane, perfluoromethylcyclohexane, 2H,3H-perfluoropentane, perfluoro(2-methyl-3-pentanone, methyl nonafluorobutyl ether, ethyl nonafluorobutyl ether, methoxy-nonafluorobutane, ethoxy-nonafluorobutane, tetradecafluoro-2-methylhexan-3-one, and tetradecafluoro-2,4-dimethylpentan-3-one), 3-methoxyperfluoro(2-methylpentane), 3-ethoxyperfluoro(2-methylpentane) fluoroalkenes and oxygenate thereof (such as perfluorohexene), and fluoroaromatic compounds (such as perfluorobenzene). Suitable chlorocarbons include, but are not limited to, chloroalkanes and oxygenates thereof (such as dichloromethane, chloroform, and 1,1,1-trichloroethane), chloroalkene and oxygenate thereof (such as trans-1,2-dichloroethylene and cis-1,2-dichloroethylene), and chloroaromatic compounds.

For example, in certain embodiments, each of the one or more halocarbons of a thermal management fluid as otherwise described herein is a fluorocarbon. In certain embodiments, the thermal management fluid as otherwise described herein is wherein the one or more halocarbons includes a fluorocarbon and a chlorocarbon (such as dichloromethane).

Some suitable commercially available halocarbons include those sold under the trade name NOVEC™ (e.g., Novec 7000, 71 DA, 71 DE, 72DA, 72DE, 72FL, 73DE, 649, 711PA, 7100, 7100DL, 774, 7200, 8200, 7300, 7300DL, 7500, and 7700) available from 3M, Saint Paul, Minn.

Based on the disclosure herein, the one or more halocarbons can be selected to have boiling point(s) relevant to the thermal process or system of interest. For example, the each halocarbon can be selected to provide a thermal “stop” to the process or system, helping to maintain temperature around the boiling point thereof even as more heat is absorbed by the thermal management fluid. When multiple halocarbons are provided, one can provide a thermal “stop” in a desired operation temperature range (e.g., 30-50° C. or 30-80° C., as described above), and another can provide a thermal stop at a higher temperature (e.g., 80-150° C. or 80-110° C., as described above) to prevent thermal runaway. Moreover, the one or more halocarbons can be selected to have low reactivity with respect to the other components of the systems in which they are used, as well as to provide the overall thermal management fluid with a desired heat capacity, thermal conductivity, and viscosity. Other considerations when selecting the one or more halocarbons may include toxicity and environmental impact.

The one or more halocarbons can be present in the thermal management fluids described herein in a variety of amounts. In certain embodiments as otherwise described herein, the one or more halocarbons is present in a total amount in the range of 0.1 wt % to 35 wt %, based on the total weight of the thermal management fluid. For example, in certain embodiments of the thermal management fluid as otherwise described herein, the one or more halocarbons are present in a total amount of 0.1 wt % to 30 wt %, or 0.1 wt % to 25 wt %, or 0.1 wt % to 20 wt %, or 0.1 wt % to 15 wt %, or 0.1 wt % to 10 wt %, or 0.1 wt % to 5 wt %, or 0.1 wt % to 1 wt %, or 0.5 wt % to 35 wt %, or 0.5 wt % to 30 wt %, or 0.5 wt % to 25 wt %, or 0.5 wt % to 20 wt %, or 0.5 wt % to 15 wt %, or 0.5 wt % to 10 wt %, or 0.5 wt % to 5 wt %, based on the total weight of the thermal management fluid. In certain embodiments of the thermal management fluid as otherwise described herein, the one or more halocarbons are present in a total amount of 1 wt % to 35 wt %, e.g., 1 wt % to 30 wt %, or 1 wt % to 25 wt %, or 1 wt % to 20 wt %, or 1 wt % to 15 wt %, or 1 wt % to 10 wt %, or 1 wt % to 5 wt %, based on the total weight of the thermal management fluid. In certain embodiments of the thermal management fluid as otherwise described herein, the one or more halocarbons are present in a total amount of 2 wt % to 35 wt %, e.g., 2 wt % to 30 wt %, or 2 wt % to 25 wt %, or 2 wt % to 20 wt %, or 2 wt % to 15 wt %, or 2 wt % to 10 wt %, or 2 wt % to 5 wt %, based on the total weight of the thermal management fluid. In certain embodiments of the thermal management fluid as otherwise described herein, the one or more halocarbons is present in a total amount of 5 wt % to 35 wt %, or 5 wt % to 30 wt %, or 5 wt % to 25 wt %, or 5 wt % to 20 wt %, or 5 wt % to 15 wt %, or 5 wt % to 10 wt %, based on the total weight of the thermal management fluid. In certain embodiments of the thermal management fluid as otherwise described herein, the one or more halocarbons is present in a total amount of 10 wt % to 35 wt %, or 10 wt % to 30 wt %, or 10 wt % to 25 wt %, or 10 wt % to 20 wt %, or 10 wt % to 15 wt %, or 15 wt % to 35 wt %, or 15 wt % to 30 wt %, or 15 wt % to 25 wt %, or 15 wt % to 20 wt %, or 20 wt % to 35 wt %, or 20 wt % to 30 wt %, or 20 wt % to 25 wt %, based on the total weight of the thermal management fluid. The person of ordinary skill in the art will provide the halocarbon(s) in an amount to provide a desired degree of heat absorption near the boiling point(s) thereof.

Throughout this specification the term “homogeneously dispersed” means that the one or more halocarbons may be present as small particles (e.g. droplets up to 10 μm, up to 50 μm, or even up to 100 μm in diameter) that are evenly (or homogeneously) mixed throughout the thermal management fluid, or that the one or more halocarbons is essentially dissolved in the thermal management fluid. It is understood that the one or more halocarbons can be homogenously dispersed yet leave a minor residue undispersed, but this will be a very small amount, i.e., less than 1%, or 0.5%, or even 0.1% by weight of the halocarbon material.

As the person of ordinary skill in the art will appreciate based, the thermal management fluids of the disclosure can also include a variety of other components, such as those conventional in compositions for thermal management applications. Examples include, but are not limited to corrosion inhibitors, anti-oxidants (such as phenolic and aminic anti-oxidants), pour point depressants, antifoams, defoamers, viscosity index modifiers, preservatives, biocides, surfactants, seal swell additives, and combinations thereof. In certain embodiments, corrosion inhibitors, anti-oxidants (such as phenolic and aminic anti-oxidants), pour point depressants, antifoams, defoamers, viscosity index modifiers, preservatives, biocides, surfactants, seal swell additives, and combinations thereof, for example, may be present in an amount up to 5.0 wt %, based on the total weight of the thermal management fluid. In certain such embodiments, one or more of corrosion inhibitors, anti-oxidants (such as phenolic and aminic anti-oxidants), pour point depressants, antifoams, defoamers, viscosity index modifiers, preservatives, biocides, surfactants, seal swell additives, and combinations thereof are present in an amount in the range of 0.1 wt % to 5.0 wt %, or 1.0 wt % to 2.0 wt %, or 0.1 wt % to 1.0 wt %, or 0.1 wt % to 0.5 wt %, or 0.05 wt % to 0.1 wt %, based on the total weight of the thermal management fluid.

The person of ordinary skill in the art will appreciate that a variety of other components can be present in the thermal management fluids of the disclosure. However, the present inventors have determined that materials that are substantially dielectric fluid in combination with halocarbon can provide the desirable activities and benefits as described herein. Thus, in certain desirable embodiments, the total amount of the one or more dielectric fluids and the one or more halocarbons is at least 80 wt % of the total weight of the thermal management fluid. In certain such embodiments, at least 85 wt %, at least 90 wt %, at least 95%, at least 98 wt %, or even at least 98 wt %, of the total weight of the thermal management fluid is made up of the one or more dielectric fluids and the one or more halocarbons. In certain embodiments as described herein, thermal management fluids of the disclosure are substantially free or free of other components and essentially only comprise or consist of the one or more dielectric fluids and the one or more halocarbons.

Because there is always a risk that oxygen might enter the system, the thermal management fluids of the disclosure advantageously have a high flash point to prevent ignition. The present inventors have noted that halocarbons can have high, or in some cases, even no flash point. Accordingly, in desirable embodiments, the vaporization the halocarbons does not pose a substantial ignition hazard, as they are not likely to ignite during operating conditions. The other components of the In certain embodiments, the flash point of the thermal management fluid of the disclosure above the boiling point of the one or more halocarbons, as measured in accordance with ASTM D56 (“Standard Test Method for Flash Point by Tag Closed Cup Tester”). For example, in certain embodiments, the thermal management fluid of the disclosure may have no measurable flash point, or a flash point of at least 90° C., e.g., at least 95° C., or at least 100° C., or at least 110° C., or at least 150° C., or even at least 200° C., measured in accordance with ASTM D56. Similarly, each of the one or more halocarbons can be selected so as to have no measurable flash point, or a flash point of at least 90° C., e.g., at least 95° C., or at least 100° C., or at least 110° C., or at least 150° C., or even at least 200° C., measured in accordance with ASTM D56.

The person of ordinary skill in the art will select components to provide the thermal management fluids with a desired viscosity, e.g., to be conveniently conducted through a system. In certain embodiments of the disclosure, the thermal management fluids of the disclosure may have a kinematic viscosity at 40° C. of 1.5 to 60 cSt, e.g., 1.5 to 50 cSt, or 1.5 to 40 cSt, or 1.5 to 20 cSt, or 1.5 to 10 cSt, or 3 to 60 cSt, or 3 to 50 cSt, or 3 to 40 cSt, or 3 to 20 cSt, or 5 to 60 cSt, or 5 to 40 cSt, or 5 to 20 cSt, or 10 to 60 cSt, or 10 to 40 cSt, as measured in accordance with ASTM D455.

In certain embodiments of the disclosure, the thermal management fluid of the disclosure may have a heat capacity of at least 1 J/g·K, or at least 1.2 J/g·K, or even at least 1.5 J/g·K at 25° C. In certain embodiments of the disclosure, the thermal management fluid of the disclosure may have a heat capacity in the range of 1 J/g·K to 4.5 J/g·K at 25° C. For example, in certain embodiments of the thermal management fluid as otherwise described herein, the heat capacity in the range of 1 J/g·K to 4 J/g·K, or 1 J/g·K to 3 J/g·K, or 1 J/g·K to 2 J/g K, or 1 J/g·K to 1.5 J/g·K, or 1.5 J/g·K to 4 J/g·K, or 1.5 J/g·K to 3.5 J/g·K, or 1.5 J/g·K to 3 J/g·K, or 1.5 J/g·K to 2 J/g·K, or 2 J/g·K to 4 J/g·K, or 2 J/g·K to 3.5 J/g·K, or 2 J/g·K to 3 J/g·K, at 25° C. The thermal management fluids of the disclosure will, of course, absorb heat through simple heating even when not in the neighborhood of a boiling point of a halocarbon thereof; the thermal management fluids can be provided with a sufficient heat capacity to provide a desired level of cooling at such temperatures.

In certain embodiments of the disclosure, the thermal management fluid of the disclosure may have a thermal conductivity in the range of 0.05 W/m·K to 1 W/m·K at 40° C. For example, in certain embodiments of the thermal management fluid as otherwise described herein, the thermal conductivity in the range of 0.05 W/m·K to 0.5 W/m·K, or 0.05 W/m·K to 0.2 W/m·K, 0.10 W/m·K to 1 W/m·K, 0.10 W/m·K to 0.5 W/m·K, or 0.10 W/m·K to 0.2 W/m·K, at 40° C.

The thermal management fluids of the disclosure are desirably dielectric, so that they can be used in direct cooling applications. Accordingly, they have a dielectric constant of at least 1.5 as measured at 25° C. The dielectric constant can be measured using the coaxial probe method, e.g., using a Keysight N1501A dielectric probe kit. In certain embodiments, a thermal management fluid of the disclosure has a dielectric constant of at least 1.75, at least 2.0, at least 2.25 as measured at 25° C. In certain embodiments, a thermal management fluid of the disclosure has a dielectric constant of at 1.5 to 10, or 1.8 to 10, or 1.5 to 2.8, or 1.8 to 2.8.

The person of ordinary skill in the art will select an amount of the first thermal management fluid of the disclosure to provide a desired amount of cooling. For example, when the electrical component is a rechargeable battery, the amount of the first thermal management fluid can be, for example, in the range of 0.01-0.2 kg per kWh of battery capacity (e.g., 0.02-0.2 kg, or 0.05-0.2 kg, or 0.1-0.2 kg, or 0.01-0.1 kg, or 0.02-0.1 kg, or 0.05-0.1 kg).

Another aspect of the disclosure provides a method comprising passing a thermal management fluid as described herein over a surface having a temperature of at least 30° C., the surface being in substantial thermal communication with a heat source, and absorbing thermal energy in the thermal management fluid from the heat source through the surface. For example, in certain embodiments, the thermal energy is absorbed at least in part by vaporizing one or more of the one or more halocarbons as the thermal management fluid is heated through the boiling point(s) of one or more of the one or more halocarbons. In certain embodiments, the method of the disclosure further includes condensing each vaporized halocarbon and returning it to the thermal management fluid. However, in other embodiments, one or more of the halocarbons (e.g., at a high temperature) may act as a thermal failsafe, and be vented from the system. In such cases, the system may need to be replenished with thermal management fluid (or, at least, the vented halocarbon component) before continuing operation—but in any event thermal runaway at an extreme temperature can be avoided.

The passing of the thermal management fluid over the surface can be performed, e.g., by pumping or otherwise flowing the fluid over the surface.

The temperature of the surface can vary; the thermal management fluid can be adapted for use with a variety of temperatures. In certain embodiments, the temperature of the surface in the range of 30 C to 150° C., e.g., 30° C. to 100° C., or 30° C. to 90° C., or 30° C. to 85° C., or 30° C. to 80° C., or 30° C. to 75° C., or 30° C. to 70° C. In certain embodiments as otherwise described herein, the temperature of the surface is in the range of 40° C. to 150° C., e.g., 50° C. to 150° C., or 60° C. to 150° C., or 70° C. to 150° C., or 80° C. to 150° C., or 90° C. to 150° C., or 100° C. to 150° C., or 110° C. to 150° C., or 30° C. to 100° C., or 40° C. to 100° C., or 50° C. to 100° C., or 60° C. to 100° C., or 70° C. to 100° C., or 80° C. to 100° C., or 30° C. to 90° C., or 40° C. to 90° C., or 50° C. to 90° C., or 60° C. to 90° C., or 30° C. to 85° C., or 40° C. to 85° C., or 45° C. to 85° C., or 50° C. to 85° C., or 60° C. to 85° C., or 30° C. to 80° C., or 40° C. to 80° C., or 45° C. to 80° C., or 50° C. to 80° C., or 60° C. to 80° C., or 30° C. to 75° C., or 40° C. to 75° C., or 45° C. to 75° C., or 50° C. to 75° C., or 60° C. to 75° C., or 30° C. to 70° C., or 40° C. to 70° C., or 45° C. to 70° C., or 50° C. to 70° C., or 60° C. to 70° C., or 65° C. to 75° C. The temperature of the surface certain embodiments (and at certain times during operation of a device or system) is within 5° C. of a boiling point of a halocarbon of the thermal management system.

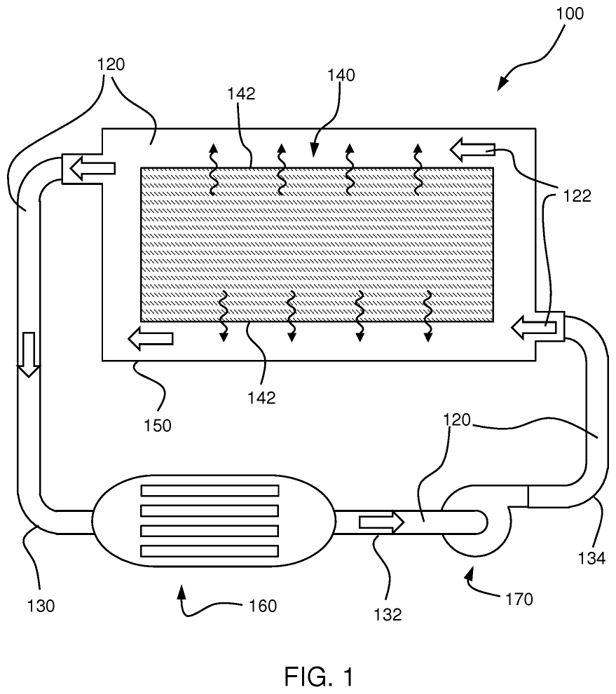

An embodiment of the method of the disclosure is illustrated with reference to FIG. 1. A thermal management circuit 100 is shown in a schematic cross-sectional side view in FIG. 1. The thermal management circuit 100 includes a thermal management fluid 120 that is circulated through the circuit and passes over surface 142. The temperature of surface 142 is elevated in comparison to the temperature of thermal management fluid 120. As a result, thermal energy is absorbed in thermal management fluid 120 from surface 142.

In certain embodiments as otherwise described herein, the method includes producing the thermal energy by operating an electrical component. For example, thermal management circuit 100 is associated with electrical component 140, which produces heat during operation. In certain embodiments the heat is produced as elements of the electrical component charge and discharge. As will be understood by those of ordinary skill in the art, inefficiencies in the operation of the electrical component and resistances in the circuits corresponding circuits create heat as current passes through the circuits and elements of the electrical component. For example, the heat from the operation of electrical component 140 causes surface 142 to rise in temperature, which then results in the transfer of thermal energy to thermal management fluid 120. In other embodiments, the thermal energy is produced by a chemical reaction, such as an exothermic reaction, or by friction. In still other embodiments, the thermal management fluid is chilled and absorbs thermal energy from surfaces at ambient or slightly elevated temperatures.

In certain embodiments as otherwise described herein, the electrical component includes a battery pack, a capacitor, inverter, electrical cabling, a fuel cell, a motor, or a computer. For example, in certain embodiments the electrical component is a battery pack that includes one or more electrochemical cells disposed in a housing. In other embodiments the electrical component is one or more capacitors, such as an electrolytic capacitor or an electric double-layer capacitor, e.g., a supercapacitor. In still other embodiments, the electrical component is one or more fuel cells, such as a polymer electrolyte membrane fuel cell, a direct methanol fuel cell, an alkaline fuel cell, a phosphoric acid fuel cell, a molten carbonate fuel cell, a solid oxide fuel cell, or a reversible fuel cell. In certain embodiments the electrical component is an electric motor. Still in other embodiments, the electrical component is a computer, for example a personal computer or a server.

In certain embodiments as otherwise described herein, the surface is a surface of the electrical component. For example, in FIG. 1 a housing of 150 of electrical component 140 contains a reservoir of thermal management fluid 120. Elements of the electrical component including certain circuits that produce heat is submerged in thermal management fluid 120 and the thermal management fluid absorbs thermal energy directly from an outside surface 142 of the electrical component 140.

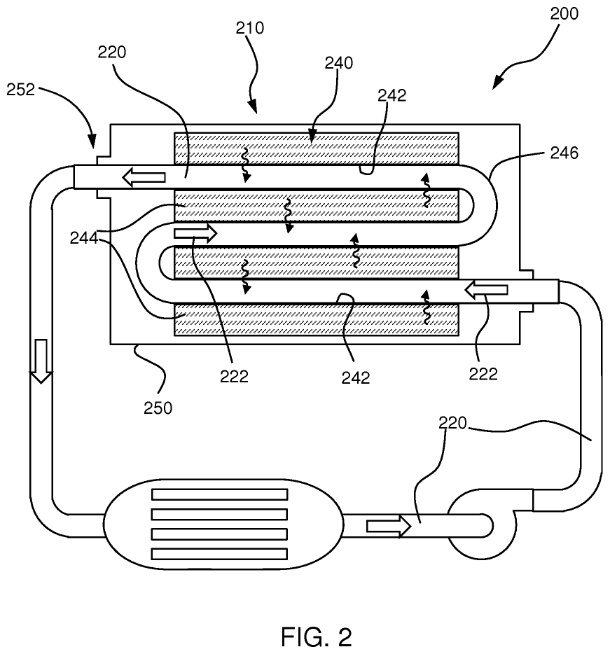

In certain embodiments as otherwise described herein, the surface is an internal surface of a conduit. For example, FIG. 2 shows a thermal management circuit 200 that includes electrical component 240 that includes a plurality of individual units 244. In particular, the electrical component 240 is a battery that includes a plurality of electrochemical cells 244. Electrical component 240 further includes a conduit 246 that extends through the inside of the electrical component and between the electrochemical cells 244. As the electrical component produces thermal energy, the internal surface 242 of the conduit 246 is heated and the thermal energy is absorbed by the thermal management fluid 220.

In certain embodiments as otherwise described herein, the conduit passes through a housing that surrounds the electrical component. For example, conduit 246 in thermal management circuit 200 extends through apertures 252 in the housing 250 surrounding electrical component 240, which allow thermal management fluid 220 to be conveyed to other elements of the thermal management circuit 200.

Another aspect of the disclosure provides a battery pack including: a housing; one or more electrochemical cells disposed in the housing; a fluid path extending through the housing and in substantial thermal communication with the one or more electrochemical cells; and a thermal management fluid according to any of the embodiments described above that is disposed in the fluid path. For example, thermal management circuit 200 in FIG. 2 includes battery pack 210. The battery pack includes a plurality of electrochemical cells 244 that are disposed inside housing 250. A conduit 246 forms a fluid path that extends through the housing. Thermal management fluid 220 disposed in conduit 246 is thereby placed in thermal communication with the electrochemical cells 244. As the electrochemical cells 244 charge and discharge they produce heat which is absorbed by the thermal management fluid 220. In certain embodiments the electrochemical cells are subject to fast charging which yields a large amount of heat. The high heat capacity of the thermal management fluid is able to absorb this large amount of heat quickly as it is produced.

In certain embodiments as otherwise described herein, the fluid path is at least partially defined by a cavity of the housing. For example, in certain embodiments at least a portion of the fluid path is formed between the electrochemical cells and the inside wall of the housing, similar to fluid path 122 in component 140.

In certain embodiments as otherwise described herein, the fluid path is at least partially defined by at least one conduit disposed in the housing. For example, in battery pack 210, conduit 246 provides the fluid path 222 through the housing 250.

In certain embodiments as otherwise described herein, the electrochemical cells are rechargeable electrochemical cells, such as lithium-ion electrochemical cells. The dielectric fluids can be especially In other embodiments, the electrochemical cells are aluminum ion cells, lead-acid cells, or magnesium ion cells.

In certain embodiments as otherwise described herein, the battery pack is a component of an electric vehicle. In some embodiments, the electric vehicle is a fully electric vehicle or a hybrid electric vehicle. In other embodiments the battery pack is part of a stationary energy storage solution, for example a home energy storage solution that operates in cooperation with local renewable energy sources, such as solar panels or wind turbines.

Another aspect of the disclosure provides a thermal management circuit including a fluid path extending around and/or through a heat source; a thermal management fluid of according to any of embodiments described above, disposed in and configured to circulate in the fluid path and to absorb thermal energy produced by the heat source, wherein the fluid is disposed in the fluid path, the heat exchanger, the pump and the connecting duct. For example, thermal management circuit 100 shown in FIG. 1 includes a fluid path 122 that runs around electrical component 140. Thermal management fluid 120 flows through path 122 absorbing thermal energy from electronic component 140. From fluid path 122, the thermal management fluid 120 flows through a first duct 130 to heat exchanger 160. Thermal energy that has accumulated in thermal management fluid 120 is removed from the fluid within heat exchanger 160 before the fluid flows through a second duct 132 to pump 170. After pump 170, the thermal management fluid 120 passes through a third duct 134 returning it to fluid path 122 surrounding electrical component 140. Circuit 100, shown in FIG. 1, is a schematic depiction of an uncomplicated embodiment employing the described thermal management fluid. In other embodiments, the thermal management circuit includes additional elements, such as any combination of valves, pumps, heat exchangers, reservoirs and ducts.

In certain embodiments of the as otherwise described herein, the heat source is a battery including a plurality of electrochemical cells, and wherein the fluid path passes between at least two of the electrochemical cells.

In certain embodiments as otherwise described herein, the fluid path is defined by a housing around the electrical component. For example, housing 150 in FIG. 1 surrounds electrical component 140 and provides a cavity for thermal management fluid 120. Electrical component 140 is held in the housing at a distance from the walls of housing 150, which allows a path for thermal management fluid 120 to form between the housing 150 and the electrical component 140. While housing 150 has an enclosed shape with specific apertures 152 providing access for thermal management fluid 120, in other embodiments the top of the housing is open and the thermal management fluid is retained in the housing by gravity.

In certain embodiments as otherwise described herein, the fluid path is configured to position the thermal management fluid in substantial thermal communication with the electrical component so as to absorb thermal energy produced by the electrical component. For example, in thermal management circuit 100 fluid path 122 extends around electrical component 140 and is in direct contact with the surfaces of electrical component 140. Further, in thermal management circuit 200 fluid path 222 passes through a conduit 246 that runs adjacent to the elements of electrical component 240. In both cases, the fluid path places thermal management fluid in close proximity to the electrical component so that the thermal management fluid readily absorbs thermal energy from the component.

In certain embodiments as otherwise described herein, the thermal management circuit further includes a heat exchanger in fluid communication with the fluid path, wherein the thermal management fluid is configured to circulate between the fluid path and the heat exchanger to dissipate heat through the heat exchanger. In certain embodiments as otherwise described herein, the heat exchanger is configured to remove heat from the thermal management fluid. For example, in thermal management circuit 100, after thermal management fluid 120 is pumped out of housing 150 it passes to heat exchanger 160 where the thermal energy is transferred to a cooler fluid, such as ambient air or a cooling liquid.

In certain embodiments as otherwise described herein, the thermal management circuit includes a battery pack according to any of the embodiments described above. For example, thermal management circuit 200 includes battery pack 210.

Various exemplary embodiments of the disclosure include, but are not limited to:

Embodiment 1 provides a dielectric thermal management fluid comprising:
one or more dielectric fluids present in a total amount in the range of 65 wt % to 99.9 wt %; and
one or more halocarbons each having a boiling point in the range of 30° C. to 150° C., present in a total amount in the range of 0.1 wt % to 35 wt %,
wherein the one or more halocarbons are homogeneously dispersed in the thermal management fluid;
wherein the dielectric thermal management fluid has a dielectric constant of at least 1.5 at 25° C.; and
wherein the thermal management fluid has a flash point that is above the boiling point of each of the one or more halocarbons.

Embodiment 2 provides the thermal management fluid of embodiment 1, wherein each of the one or more dielectric fluids has a thermal conductivity of at least 0.05 W/m·K at 25° C.

Embodiment 3 provides the thermal management fluid of embodiment 1 or embodiment 2, wherein each of the one or more dielectric fluids has a specific heat capacity of at least 1 J/g·K at 25° C.

Embodiment 4 provides the thermal management fluid of any of embodiments 1-3, wherein each of the one or more dielectric fluids is selected from aliphatic dielectric fluids (e.g., C₁₄-C₅₀ alkyls, C₁₄-C₅₀ alkenyls, C₁₄-C₅₀ alkynyls, polyolefins such as poly-α-olefin), aliphatic dielectric fluid oxygenates (e.g., ketones, ethers, esters, or amides), aromatic dielectric fluids (e.g., dialkylbenzene such as diethylbenzene, cyclohexylbenzene, 1-alkylnaphthalene, 2-alkylnaphthalene, dibenzyltoluene, and alkylated biphenyl), aromatic dielectric fluid oxygenates (e.g., ketones, ethers, esters, or amides), silicones (e.g., silicone oil and silicate ester), and any combination thereof.

Embodiment 5 provides the thermal management fluid of any of embodiments 1-3 wherein each of the one or more dielectric fluids is selected from C₁₄-C₅₀ alkyls, polyolefins, and any combination thereof.

Embodiment 6 provides the thermal management fluid of any of embodiments 1-3, wherein each of the one or more dielectric fluids is a mineral oil, a synthetic oil, or a silicone oil.

Embodiment 7 provides the thermal management fluid of any of embodiments 1-6, wherein the one or more dielectric fluids are present in a total amount of 70 wt % to 99.9 wt %, or 75 wt % to 99.9 wt %, or 80 wt % to 99.9 wt %, or 85 wt % to 99.9 wt %, or 90 wt % to 99.9 wt %, or 95 wt % to 99.9 wt %, or 65 wt % to 99 wt %, or 70 wt % to 99 wt %, or 75 wt % to 99 wt %, or 80 wt % to 99 wt %, or 85 wt % to 99 wt %, or 90 wt % to 99 wt %, or 95 wt % to 99 wt %, based on the total weight of the thermal management fluid.

Embodiment 8 provides the thermal management fluid of any of embodiments 1-6, wherein the one or more dielectric fluids are present in a total amount of 65 wt % to 98 wt %, e.g., 70 wt % to 99 wt %, or 75 wt % to 98 wt %, or 80 wt % to 98 wt %, or 85 wt % to 98 wt %, or 90 wt % to 98 wt %, or 95 wt % to 98 wt %, or 65 wt % to 95 wt %, or 70 wt % to 95 wt %, or 75 wt % to 95 wt %, or 80 wt % to 95 wt %, or 85 wt % to 95 wt %, or 90 wt % to 95 wt %, based on the total weight of the thermal management fluid.

Embodiment 9 provides the thermal management fluid of any of embodiments 1-6, wherein the one or more dielectric fluids are present in a total amount of 65 wt % to 90 wt %, e.g., 70 wt % to 90 wt %, or 75 wt % to 90 wt %, or 80 wt % to 90 wt %, or 85 wt % to 90 wt %, or 65 wt % to 85 wt %, or 70 wt % to 85 wt %, or 75 wt % to 85 wt %, or 80 wt % to 85 wt %, or 65 wt % to 80 wt %, or 70 wt % to 80 wt %, or 75 wt % to 80 wt %, based on the total weight of the thermal management fluid.

Embodiment 10 provides the thermal management fluid of any of embodiments 1-9, wherein each of the one or more halocarbons has a boiling point in the range of 30° C. to 100° C., or 30° C. to 90° C., or 30° C. to 85° C., or 30° C. to 80° C., or 30° C. to 75° C., or 30° C. to 70° C.

Embodiment 11 provides the thermal management fluid of any of embodiments 1-9, wherein each of the one or more halocarbons has a boiling point in the range of 40° C. to 150° C., e.g., 50° C. to 150° C., or 60° C. to 150° C., or 70° C. to 150° C., or 80° C. to 150° C., or 90° C. to 150° C., or 100° C. to 150° C., or 110° C. to 150° C., or 40° C. to 100° C., or 50° C. to 100° C., or 60° C. to 100° C., or 70° C. to 100° C., or 80° C. to 100° C., or 40° C. to 90° C., or 50° C. to 90° C., or 60° C. to 90° C., or 40° C. to 85° C., or 45° C. to 85° C., or 50° C. to 85° C., or 60° C. to 85° C., or 40° C. to 80° C., or 45° C. to 80° C., or 50° C. to 80° C., or 60° C. to 80° C., or 40° C. to 75° C., or 45° C. to 75° C., or 50° C. to 75° C., or 60° C. to 75° C., or 40° C. to 70° C., or 45° C. to 70° C., or 50° C. to 70° C., or 60° C. to 70° C., or 65° C. to 75° C.

Embodiment 12 provides the thermal management fluid of any of embodiments 1-9, wherein the one or more halocarbons comprises a first halocarbon having a boiling point in the range of 30° C. to 50° C. and a second halocarbon having a boiling point in the range of 80° C. to 110° C.

Embodiment 13 provides the thermal management fluid of any of embodiments 1-12, wherein each of the one or more halocarbons includes as its halogen(s) one or more or chlorine, fluorine and bromine.

Embodiment 14 provides the thermal management fluid of any of embodiments 1-12, wherein each of the one or more halocarbons is selected from fluorocarbon, chlorocarbon, and chlorofluorocarbon.

Embodiment 15 provides the thermal management fluid of any of embodiments 1-12, wherein the one or more halocarbons include a fluorocarbon and a chlorocarbon (such as dichloromethane).

Embodiment 16 provides the thermal management fluid of any of embodiments 1-15, wherein at least one of the one or more halocarbons is a chlorocarbon selected from chloroalkanes and oxygenates thereof (such as dichloromethane, chloroform, and 1,1,1-trichloroethane), chloroalkene and oxygenate thereof (such as trans-1,2-dichloroethylene and cis-1,2-dichloroethylene), and chloroaromatic compounds.

Embodiment 17 provides the thermal management fluid of any of embodiments 1-12, wherein each of the one or more halocarbons is a fluorocarbon.

Embodiment 18 provides the thermal management fluid of any of embodiments 1-17, wherein at least one of the one or more halocarbons is a fluorocarbon selected from fluoroalkanes and oxygenates thereof (such as perfluoropentane, perfluorohexane, perfluoroheptane, perfluorocyclohexane, perfluoromethylcyclohexane, 2H,3H-perfluoropentane, perfluoro(2-methyl-3-pentanone), methyl nonafluorobutyl ether, ethyl nonafluorobutyl ether, methoxy-nonafluorobutane, ethoxy-nonafluorobutane, tetradecafluoro-2-methylhexan-3-one, and tetradecafluoro-2,4-dimethylpentan-3-one), 3-methoxyperfluoro(2-methylpentane), 3-ethoxyperfluoro(2-methylpentane) fluoroalkenes and oxygenate thereof (such as perfluorohexene), and fluoroaromatic compounds (such as perfluorobenzene).

Embodiment 19 provides the thermal management fluid of any of embodiments 1-19, wherein each of the one or more halocarbons has no measureable flash point, or a flash point of at least 90° C., e.g., at least 95° C., or at least 100° C., or at least 110° C., or at least 150° C., or even at least 200° C., measured in accordance with ASTM D56.

Embodiment 20 provides the thermal management fluid of any of embodiments 1-19, wherein the one or more halocarbons are present in a total amount of 0.1 wt % to 30 wt %, or 0.1 wt % to 25 wt %, or 0.1 wt % to 20 wt %, or 0.1 wt % to 15 wt %, or 0.1 wt % to 10 wt %, or 0.1 wt % to 5 wt %, or 0.1 wt % to 1 wt %, based on the weight of the thermal management fluid.

Embodiment 21 provides the thermal management fluid of any of embodiments 1-19, wherein the one or more halocarbons are present in a total amount of 1 wt % to 35 wt %, or 1 wt % to 30 wt %, or 1 wt % to 25 wt %, or 1 wt % to 20 wt %, or 1 wt % to 15 wt %, or 1 wt % to 10 wt %, or 1 wt % to 5 wt %, based on the total weight of the thermal management fluid.

Embodiment 22 provides the thermal management fluid of any of embodiments 1-19, wherein the one or more halocarbons are present in a total amount of 2 wt % to 35 wt %, or 2 wt % to 30 wt %, or 2 wt % to 25 wt %, or 2 wt % to 20 wt %, or 2 wt % to 15 wt %, or 2 wt % to 10 wt %, or 2 wt % to 5 wt %, based on the total weight of the thermal management fluid.

Embodiment 23 provides the thermal management fluid of any of embodiments 1-19, wherein the one or more halocarbons are present in a total amount of 5 wt % to 35 wt %, or 5 wt % to 30 wt %, or 5 wt % to 25 wt %, or 5 wt % to 20 wt %, or 5 wt % to 15 wt %, or 5 wt % to 10 wt %, based on the total weight of the thermal management fluid

Embodiment 24 provides the thermal management fluid of any of embodiments 1-19, wherein the one or more halocarbons are present in a total amount of 10 wt % to 35 wt %, or 10 wt % to 30 wt %, or 10 wt % to 25 wt %, or 10 wt % to 20 wt %, or 10 wt % to 15 wt %, or 15 wt % to 35 wt %, or 15 wt % to 30 wt %, or 15 wt % to 25 wt %, or 15 wt % to 20 wt %, or 20 wt % to 35 wt %, or 20 wt % to 30 wt %, or 20 wt % to 25 wt %, based on the total weight of the thermal management fluid.

Embodiment 25 provides the thermal management fluid of any of embodiments 1-24, further comprising corrosion inhibitors, anti-oxidants (such as phenolic and aminic anti-oxidants), pour point depressants, antifoams, defoamers, viscosity index modifiers, preservatives, biocides, surfactants, seal swell additives, and combinations thereof, e.g., in an amount up to 0.5 wt %, up to 1.0 wt %, or up to 5.0 wt %.

Embodiment 26 provides the thermal management fluid of any of embodiments 1-25, wherein the total amount of the one or more dielectric fluids and the one or more halocarbons in the thermal management fluid is at least 80%, e.g., at least 85%.

Embodiment 27 provides the thermal management fluid of any of embodiments 1-25, wherein the total amount of the one or more dielectric fluids and the one or more halocarbons in the thermal management fluid is at least 90%, at least 95%, or at least 98%.

Embodiment 28 provides the thermal management fluid of any of embodiments 1-27, having no measurable flash point, or a flash point of at least 90° C., e.g., at least 95° C., or at least 100° C., or at least 110° C., or at least 150° C., or even at least 200° C., measured in accordance with ASTM D56.

Embodiment 29 provides the thermal management fluid of any of embodiments 1-27 having a kinematic viscosity at 40° C. of 1.5 to 60 cSt.

Embodiment 30 provides a method comprising:
passing a thermal management fluid of embodiments 1-29 over a surface having a temperature of at least 30° C., the surface being in substantial thermal communication with a heat source; and
absorbing thermal energy in the thermal management fluid from the heat source through the surface.

Embodiment 31 provides the method of embodiment 30, wherein the thermal energy is absorbed at least in part by vaporizing one or more of the halocarbons as the thermal management fluid is heated through the boiling point(s) of the one or more halocarbons.

Embodiment 32 provides the method according to embodiment 31, further comprising condensing the one or more vaporized halocarbons and returning them to the thermal management fluid.

Embodiment 33 provides the method of any of embodiments 30-32, wherein the heat source is an operating electrical component.

Embodiment 34 provides the method of embodiment 33, wherein the heat source is a battery pack, a capacitor, inverter, electrical cabling, a fuel cell, a motor, or a computer.

Embodiment 35 provides the method of embodiment 33 or embodiment 34, wherein the surface is a surface of the electrical component.

Embodiment 36 provides the method of any of embodiments 30-35, wherein the surface is an internal surface of a conduit in substantial thermal communication with the heat source.

Embodiment 37 provides the method according to embodiment 36, wherein the conduit passes through a housing that surrounds the electrical component.

Embodiment 38 provides a battery pack comprising:
a housing;
one or more electrochemical cells disposed in the housing;
a fluid path extending through the housing and in substantial thermal communication with the one or more electrochemical cells; and
a thermal management fluid of embodiments 1-29 disposed in the fluid path.

Embodiment 39 provides the battery pack of embodiment 38, wherein the fluid path is at least partially defined by a cavity of the housing.

Embodiment 40 provides the battery pack of embodiment 38 or embodiment 39, wherein the fluid path is at least partially defined by at least one conduit disposed in the housing.

Embodiment 41 provides the battery pack of any of embodiments 38-40, wherein the electrochemical cells are lithium-ion electrochemical cells.

Embodiment 42 provides an electric vehicle comprising the battery pack of any of embodiments 38-41.

Embodiment 43 provides a thermal management circuit comprising:
a fluid path extending around and/or through a heat source;
a thermal management fluid of embodiments 1-29, disposed in and configured to circulate in the fluid path and to absorb thermal energy produced by the heat source,
wherein the fluid is disposed in the fluid path, the heat exchanger, the pump and the connecting duct.

Embodiment 44 provides the thermal management circuit of embodiment 43, further comprising a pump operatively connected to the fluid path and configured to circulate the thermal management fluid in the fluid path.

Embodiment 45 provides the thermal management circuit of embodiment 43 or embodiment 44, further comprising a heat exchanger in fluid communication with the fluid path, wherein the thermal management fluid is configured to circulate between the fluid path and the heat exchanger to dissipate heat through the heat exchanger.

Embodiment 46 provides the thermal management circuit of any of embodiments 43-45, wherein the fluid path is defined by a housing around the heat source.

Embodiment 47 provides the thermal management circuit of any of embodiments 43-46, wherein the heat source is an electrical component.

Embodiment 48 provides the thermal management circuit of any of embodiments 43-45, wherein the heat source is a battery including a plurality of electrochemical cells, and wherein the fluid path passes between at least two of the electrochemical cells.

It will be apparent to those skilled in the art that various modifications and variations can be made to the processes and devices described here without departing from the scope of the disclosure. Thus, it is intended that the present disclosure cover such modifications and variations of this invention provided they come within the scope of the appended claims and their equivalents.

It is understood that the examples and embodiments described herein are for illustrative purposes only and that various modifications or changes in light thereof will be suggested to persons skilled in the art and are to be incorporated within the spirit and purview of this application and scope of the appended claims. All publications, patents, and patent applications cited herein are hereby incorporated herein by reference for all purposes.

1. A dielectric thermal management fluid comprising:
one or more dielectric fluids present in a total amount in the range of 65 wt % to 99.9 wt %; and
one or more halocarbons each having a boiling point in the range of 30° C. to 150° C., present in a total amount in the range of 0.1 wt % to 35 wt %,
wherein the one or more halocarbons are homogeneously dispersed in the thermal management fluid;
wherein the dielectric thermal management fluid has a dielectric constant of at least 1.5 at 25° C.; and
wherein the thermal management fluid has a flash point that is above the boiling point of each of the one or more halocarbons.

2. The thermal management fluid of claim 1, wherein each of the one or more dielectric fluids is selected from aliphatic dielectric fluids, aliphatic dielectric fluid oxygenates, aromatic dielectric fluids, aromatic dielectric fluid oxygenates, silicones, and any combination thereof.

3. The thermal management fluid of claim 1, wherein each of the one or more dielectric fluids is selected from C₁₄-C₅₀ alkyls, polyolefins, and any combination thereof.

4. The thermal management fluid of claim 1, wherein the one or more dielectric fluids are present in a total amount of 70 wt % to 99.9 wt % based on the total weight of the thermal management fluid.

5. The thermal management fluid of claim 1, wherein each of the one or more halocarbons has a boiling point in the range of 30° C. to 100° C.

6. The thermal management fluid of claim 1, wherein each of the one or more halocarbons is selected from fluorocarbon, chlorocarbon, and chlorofluorocarbon.

7. The thermal management fluid of claim 1, wherein at least one of the one or more halocarbons is a chlorocarbon selected from chloroalkanes and oxygenates thereof, chloroalkene and oxygenate thereof, and chloroaromatic compounds.

8. The thermal management fluid of claim 1, wherein at least one of the one or more halocarbons is a fluorocarbon selected from fluoroalkanes and oxygenates thereof, 3-methoxyperfluoro(2-methylpentane), 3-ethoxyperfluoro(2-methylpentane) fluoroalkenes and oxygenate thereof, and fluoroaromatic compounds.

9. The thermal management fluid of claim 1, wherein the one or more halocarbons are present in a total amount of 0.1 wt % to 30 wt % based on the weight of the thermal management fluid.

10. The management fluid of claim 1, wherein the one or more halocarbons are present in a total amount of 2 wt % to 35 wt %, based on the weight of the thermal management fluid.

11. The thermal management fluid of claim 1, having no measurable flash point, or a flash point of at least 90° C., or even at least 200° C., measured in accordance with ASTM D56.

12. The thermal management fluid of claim 1, wherein the total amount of the one or more dielectric fluids and the one or more halocarbons in the thermal management fluid is at least 80%.

13. A method comprising:
passing a thermal management fluid of claim 1 over a surface having a temperature of at least 30° C., the surface being in substantial thermal communication with a heat source; and
absorbing thermal energy in the thermal management fluid from the heat source through the surface, wherein the thermal energy is absorbed at least in part by vaporizing one or more of the halocarbons as the thermal management fluid is heated through the boiling point(s) of the one or more halocarbons.

14. A battery pack comprising:
a housing;
one or more electrochemical cells disposed in the housing;
a fluid path extending through the housing and in substantial thermal communication with the one or more electrochemical cells; and
a thermal management fluid of claim 1 disposed in the fluid path.

15. The battery pack of claim 14, wherein the electrochemical cells are lithium-ion electrochemical cells.

16. An electric vehicle comprising the battery pack of claim 14.

17. A thermal management circuit comprising:
a fluid path extending around and/or through a heat source;
a thermal management fluid of claim 1, disposed in and configured to circulate in the fluid path and to absorb thermal energy produced by the heat source,
wherein the fluid is disposed in the fluid path, the heat exchanger, the pump and the connecting duct.

18. The thermal management fluid of claim 1, wherein each of the one or more dielectric fluids has a thermal conductivity of at least 0.05 W/m·K at 25° C.

19. The thermal management fluid of claim 1, wherein each of the one or more dielectric fluids has a specific heat capacity of at least 1 J/g·K at 25° C.

20. The thermal management fluid of claim 1 having a kinematic viscosity at 40° C. of 1.5 to 60 cSt.
